(19) United States
(12) Patent Application Publication
(10) Pub. No.: US 2025/0050289 A1
(43) Pub. Date: Feb. 13, 2025

(54) BLENDER FOR MAKEUP

(71) Applicant: Yael GOLDMAN, Petach Tikva (IL)

(72) Inventor: Yael GOLDMAN, Petach Tikva (IL)

(21) Appl. No.: 18/718,449

(22) PCT Filed: Dec. 29, 2022
(86) PCT No.: PCT/IB2022/062876

§ 371 Date: Jun. 11, 2024

Related U.S. Application Data
(60) Provisional application No. 63/295,954, filed on Jan. 3, 2022.

(51) Int. Cl. B01F 27/906; A45D 33/00; A45D 33/26; B01F 27/091; B01F 27/1123; B01F 35/32; B01F 35/33; B01F 35/45; B01F 101/21

(52) U.S. Cl. CPC B01F 27/906; A45D 33/26; B01F 27/091; B01F 27/1123; B01F 35/3202; B01F 35/3214; B01F 35/33; B01F 35/453; A45D 2033/001; A45D 2200/058; B01F 2101/21

(57) ABSTRACT

A blender for blending a plurality of ingredients. The blender has an upper cover, comprising a rotation mechanism, and the upper cover is fitted on a lower mixing compartment. The rotation mechanism comprises a rotor, and rotation of the upper cover rotates the rotor, and the rotor blends the multitude of ingredients within the lower mixing compartment for receiving a blended mixture.

### FIELD OF THE INVENTION

The present invention relates to the field of containers for mixing cosmetic ingredients such as makeup, and more particularly to the field of containers for mixing cosmetic ingredients such as makeup foundation shades.

### BACKGROUND OF THE INVENTION

Mixing of creams, pastes, powders and liquids for foundation shades and concealer tones is a frequent need in the cosmetics industry. Known methods of mixing such ingredients are done by putting the ingredients on one hand, and then, mixing the mixture by the other hand. These methods are unhygienic and also lead to material waste. Other methods of mixing such ingredients are done on a small bowl or palette, typically made of ceramic, glass, metal or wood, on which the required ingredients are placed, and then, mixed with the aid of a makeup brush or a small spatula which has a rounded-head, flat-head, or tipped-head, typically made of stainless steel, plastic or wood.

Such a mixing method suffers three major drawbacks. First, it is time consuming, either during a primary mixing or during a secondary mixing after adding a desired ingredient into the mixture, when the entire mixture has to be thoroughly re-mixed in order to assure proper mixing of the entire mixture with the new-added ingredient.

Second, despite a thorough mixing during a considerable amount of time, there can remain residues of one ingredient within the entire mixture. Thus, when applying the mixture on the face of a user, a line of a different color or tone may appear on the face which is an unpleasant result that is sometimes difficult to fix.

Third, since typically there are various ingredients involved, their specific quantities within the mixture cannot always be pre-set, therefore, they are used in trial-and-error additions to the mixture. This means that during the mixing, when adding one ingredient and not receiving the desired result, another ingredient must be added, and then mixed with the entire mixture. This process may take place several times until the final mixture/tone are satisfying. Such a process typically ends with a considerable amount of residual material that is unused, and therefore, lost.

### SUMMARY OF THE INVENTION

The present invention is a blender for mixing ingredients.

An advantage of the present invention is that it blends ingredients in a hygienic manner.

According to the present invention there is provided a blender for blending a plurality of ingredients, the blender comprising:
an upper cover, comprising a rotation mechanism, the upper cover fitted on a lower mixing compartment, wherein:
the rotation mechanism comprises a rotor, and
rotation of the upper cover rotates the rotor, and the rotor blends the multitude of ingredients within the lower mixing compartment for receiving a blended mixture.

Typically, the ingredients include cosmetic ingredients.

Further typically, the plurality of ingredients are makeup foundations.

If desired, the plurality of ingredients are concealer tones.

Advantageously, the lower mixing compartment comprises a concave indentation in a lower portion thereof, and, rotation of the rotor blends the mixture within the lower mixing compartment and wipes the mixture from the concave indentation.

Practically, the rotor comprises a center hub and at least one wing extending generally radially outwardly from the hub.

If desired, a bottom surface of the at least one wing comprises at least one upwardly extending cutout.

Further if desired, the bottom surface of the at least one wing comprises at least one wiping protrusion formed between two adjacent cutouts.

Practically, the rotor comprises a center hub having a bottom wall, and the bottom wall of the hub mates with a shape of the concave indentation.

In some embodiments, the concave indentation comprises a plurality of zones, each of which extends radially outwardly from a former zone.

If desired, each of the plurality of zones having a different radius of curvature.

Advantageously, the rotation mechanism comprises gearwheels mechanically linked such as to increase rotation speed and number of turns of the rotor with respect to rotation speed and number of turns of the upper cover.

Practically, the rotor is mechanically linked to a driving shaft of a pinion that is aligned with a longitudinal axis of the blender,
the pinion is engaged with an intermediate gearwheel having an axis of rotation that is fixed with respect to the lower mixing compartment,
the intermediate gearwheel is engaged with an internal gear formed in an internal portion of the upper cover, and wherein
rotation of the upper cover in an upper cover rotation direction turns the rotor in a rotor rotation direction that is opposite the upper cover rotation direction.

In some embodiments, the intermediate gearwheel comprises a central pin extending downwardly therefrom,
the central pin is held within a fixing hole of a cover plate that is fixed with respect to the lower mixing compartment, and wherein
the central pin can freely rotate within the fixing hole, while any translational movement of the central pin in a plane perpendicular to the longitudinal axis of the blender is successfully prevented.

Advantageously, the cover plate comprises a fixing pin extending downwardly therefrom,
the fixing pin conforms in size and shape to a fixing indentation formed in the lower mixing compartment, and wherein
insertion of the fixing pin into the fixing indentation prevents any rotational movement of the cover plate with respect to the lower mixing compartment.

Practically, the lower mixing compartment comprises a plurality of fixing indentations.

Advantageously, the upper cover comprises an upper magnet, the lower mixing compartment comprises a lower magnet, and wherein
the upper cover remains engaged with the lower mixing compartment by the attraction between the upper magnet and the lower magnet.

Practically, the upper magnet is aligned with a longitudinal axis of the blender and is embedded within a driving shaft that rotates the rotor.

If desired, the lower mixing compartment is assembled from a mixing plate that is engaged with a lower holding compartment,
the lower magnet is embedded into the lower holding compartment from an upper side thereof, and wherein
when the mixing plate is engaged with the lower holding compartment, the lower magnet cannot be seen from outside the blender.

Advantageously, the upper cover comprises at least one directional guide,
the lower mixing compartment comprises at least one directional stopper, and wherein
when the upper cover is engaged with the lower mixing compartment and rotated in an upper cover rotation direction until the at least one directional guide meets the at least one directional stopper, rotation of the rotor in a rotor rotation direction is enabled, and wherein
when the upper cover is rotated in a direction opposite to the upper cover rotation direction, rotation of the upper cover with respect to the lower mixing compartment is prevented, and a one-direction rotation mechanism is obtained.

Advantageously, when the upper cover is rotated in an upper cover rotation direction until the at least one directional guide meets the at least one directional stopper, a guide slanted surface of the directional guide slides on a stopper slanted surface of the directional stopper, thus moving the upper cover axially away from the lower mixing compartment until the directional guide ends its travel on the directional stopper, then, the upper cover moves axially back toward the lower mixing compartment, thus obtaining an intermittent axial movement of the upper cover with respect to the lower mixing compartment during rotation of the upper cover in an upper cover rotation direction with respect to the lower mixing compartment.

In some embodiments, the upper cover comprises four directional guides, and, the lower mixing compartment comprises four directional stoppers.

### BRIEF DESCRIPTION OF THE DRAWINGS

For a better understanding of the present invention and to show how the same may be carried out in practice, reference will now be made to the accompanying drawings, in which:

FIG. 1 is a bottom perspective view of a blender according to embodiments of the present invention;

FIG. 2 is an exploded view of the blender of FIG. 1, showing an upper cover, an intermediate gearwheel, a pinion, a cover plate, a rotor, a mixing plate, and a lower mixing compartment, according to embodiments of the present invention;

FIG. 3 is a top partially exploded view of the blender of FIG. 1;

FIG. 4 is a top perspective view of the rotor of FIGS. 2 and 3, according to embodiments of the present invention;

FIG. 5 is a bottom perspective view of the rotor corresponding to FIG. 4;

FIG. 6 is a side view of the rotor;

FIG. 7 is a bottom view of the rotor;

FIG. 8 is a side cross-sectional view of the blender of FIG. 1 showing the upper cover, the intermediate gearwheel, the pinion, the cover plate, and the rotor, which form a rotation mechanism, according to embodiments of the present invention;

FIG. 9 is a top view of the intermediate gearwheel engaged with the pinion, with the upper cover removed;

FIG. 10 is a side cross-sectional view of the blender of FIG. 1 taken along line X-X in FIG. 9, with the upper cover removed, showing the intermediate gearwheel, the pinion, the cover plate, and the rotor, which together with the upper cover form the rotation mechanism, according to embodiments of the present invention;

FIG. 11 is a side view of the rotation mechanism shown in FIG. 10;

FIG. 12 is a top perspective view of the rotation mechanism shown in FIG. 11; and

FIG. 13 is a side enlarged view of the one-direction rotation mechanism of FIGS. 11 and 12.

### DESCRIPTION OF PREFERRED EMBODIMENTS

The present invention is a blender for mixing ingredients.

The principles and operation of the blender according to the present invention may be better understood with reference to the drawings accompanying the description.

Before explaining at least one embodiment of the invention in detail, it is to be understood that the invention is not necessarily limited in its application to the details of construction and the arrangement of the components and/or methods set forth in the following description and/or illustrated in the drawings and/or the examples. The invention is capable of other embodiments or of being practiced or carried out in various ways. Initially, throughout this document, references are made to directions, such as, for example, top and bottom, upper and lower, front and back, and the like. These directional references are exemplary only, and are used only for ease of presentation and refer to the arbitrary orientations as illustrated in the drawings.

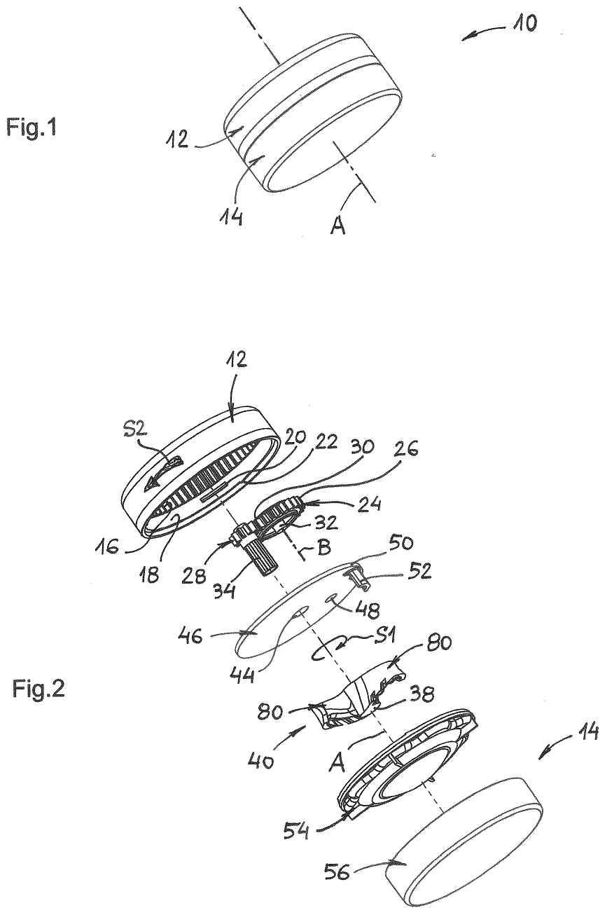

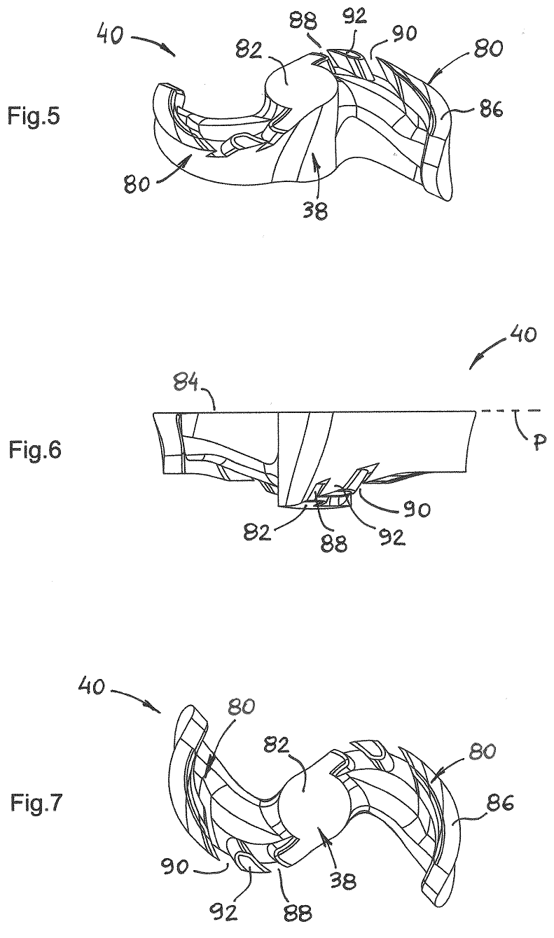

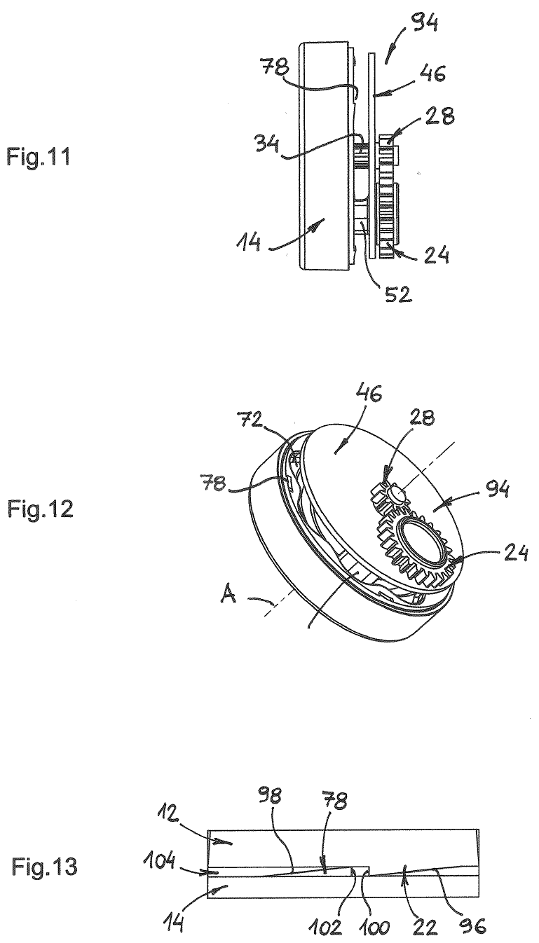

Attention is drawn to FIGS. 1-13 that show a blender 10 according to certain embodiments of the present invention. The blender is typically used to blend makeup foundations, hereinafter called “mixture”. As shown in FIG. 1, the blender 10 has a cylindrical shape, a longitudinal axis A, and comprises two main portions; an upper cover 12 that is fitted on a lower mixing compartment 14.

As clearly seen in FIG. 2, the upper cover 12 comprises, in an internal and upper portion thereof, an internal gear 16. Downwardly to the internal gear 16 and located on an internal wall 18 of the upper cover 12 are four radially inwardly directed and equally peripherally spaced locking protrusions 20 (only two of which are shown in the figure). Downwardly to the locking protrusions 20, the upper cover 12 comprises four directional guides 22 that are formed along the internal wall 18 of the upper cover 12.

An intermediate gearwheel 24, having an axis of rotation B, is in engagement with the internal gear 16, at a radially outwardly side 26 of the intermediate gearwheel 24, remote, i.e., radially offset, from the longitudinal axis A, and, with a pinion 28, at a radially inwardly side 30 of the intermediate gearwheel 24, adjacent the longitudinal axis A, diametrically opposite to the radially outwardly side 26 of the intermediate gearwheel 24.

The intermediate gearwheel 24 is provided, at a lower side thereof, with a central pin 32 that is axially aligned with the axis of rotation B of the intermediate gearwheel 24 and extending downwardly from the intermediate gearwheel 24.

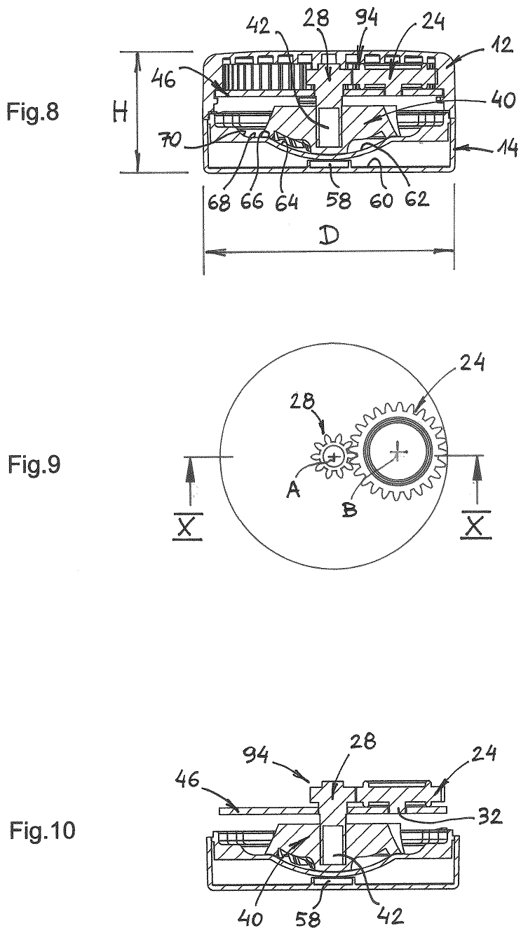

The pinion 28, which is aligned with the longitudinal axis A of the blender 10, has a downwardly extending driving shaft 34. The driving shaft 34 is shaped such that it mates with a central aperture 36 of a hub 38 of a rotor 40 that is driven by the driving shaft 34. The definition of a rotor includes any rotatable member, such as an agitator, that can agitate/mix ingredients. A cylindrically-shaped upper magnet 42 (FIG. 8) is embedded into a lower portion of the driving shaft 34, coaxial with the longitudinal axis A of the blender 10.

Prior to connecting to the hub 38, the driving shaft 34 freely passes through a center hole 44 of a cover plate 46. The cover plate 46 is axially aligned with the longitudinal axis A of the blender 10 and is provided with a fixing hole 48. The fixing hole 48 is axially aligned with the axis of rotation B of the intermediate gearwheel 24 that is parallel to the longitudinal axis A of the blender 10. The fixing hole 48 holds therein the central pin 32 of the intermediate gearwheel 24 such that the central pin 32 can freely rotate, while any translational movement thereof in a plane perpendicular to the longitudinal axis A of the blender 10 is successfully prevented.

The cover plate 46 is locked into the upper cover 12 by means of a close-fit between a peripheral edge 50 of the cover plate 46 and the locking protrusions 20 of the upper cover 12. The cover plate 46 is further provided with a fixing pin 52 for preventing any rotational movement of the cover plate 46 as will be later described. The fixing pin 52 is positioned adjacent the peripheral edge 50 of the cover plate 46 and extends downwardly therefrom.

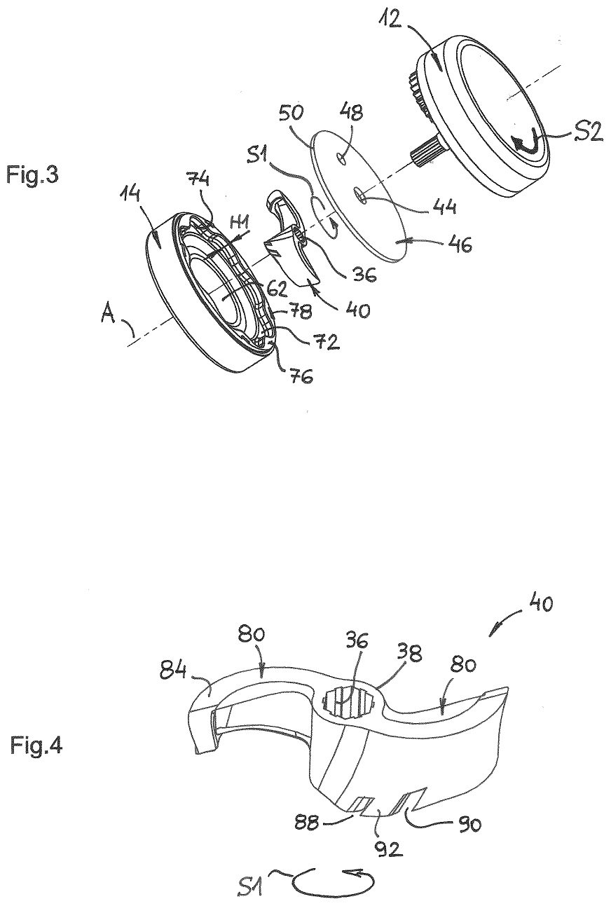

According to embodiments of the present embodiment, the lower mixing compartment 14 is produced from two different parts, for the ease of production, and comprises a mixing plate 54 that is assembled into a lower holding compartment 56. In FIG. 2, the mixing plate 54 and the lower holding compartment 56 are shown separately, in a pre-assembled state. In FIG. 3, the mixing plate 54 is shown assembled into the lower holding compartment 56 thus forming, together, the lower mixing compartment 14 of the blender 10.

The lower holding compartment 56 comprises a disc-shaped lower magnet 58 (FIG. 8) that is embedded into a lower wall 60 of the lower holding compartment 56, from an upper side thereof, and aligned with the longitudinal axis A of the blender 10. Thus, when the mixing plate 54 is engaged with the lower holding compartment 56, the lower magnet 58 cannot be seen from outside the blender 10.

As illustrated in FIG. 8, the mixing plate 54 comprises, in a central portion thereof, a bowl-shaped concave indentation 62 for receiving therein ingredients to be blended by the blender 10. According to some embodiments, the concave indentation 62 consists of various zones, each of which having a different radius of curvature. A centrally located concave first zone 64, a transitional convex second zone 66, radially outwardly from the first zone, a planar third zone 68, radially outwardly from the second zone, and, a peripheral concave fourth zone 70, radially outwardly from the third zone.

As illustrated in FIG. 3, the mixing plate 54 comprises, radially outwardly from the concave indentation 62, a multitude of fixing indentations 72. Each of the fixing indentations 72 extends axially, i.e., has a height dimension H1 in a direction parallel to the longitudinal axis A, and, having a peripheral wall 74 that conforms in size and shape to the fixing pin 52 of the cover plate 46.

The mixing plate 54 further comprises, on an upper face 76 thereof, four equally peripherally distributed and upwardly extending directional stoppers 78, for preventing rotation of the rotor 40 in a wrong direction as will be later described.

As illustrated in FIGS. 4-7, the rotor 40 has two wings 80 that extend generally radially outwardly from the hub 38. The term “generally” is used since the wings are curved and do not extend radially outwardly in a straight line. A bottom wall 82 of the hub 38 is convex and mates with the concave shape of the first zone 64 of the concave indentation 62 of the mixing plate 54.

Each wing 80 is generally concave in a rotor rotation direction S1 and generally convex in an opposite direction. The rotor 40 has an upper side 84 that is planar and lies in a plane P that is perpendicular to the longitudinal axis A.

A bottom surface 86 of each wing 80, adapted to wipe the mixture within the mixing plate 54, is provided with two upwardly extending cutouts. A first cutout 88 located adjacent the hub 38, and, a second cutout 90 located radially outwardly with respect to the first cutout 88. The area between the first cutout 88 and the second cutout 90 consists of a wiping protrusion 92.

The blender 10 is easy to carry and use. According to a specific embodiment of the present invention, the blender 10 has a height H of 32 mm and a diameter D of 66 mm so it is easily carried and comfortably fit within a palm of a user when it is in use.

Prior to being used by a user, the blender 10 is pre-assembled by its manufacturer. First, in a case that the mixing plate 54 is produced separately from the lower holding compartment 56, they are permanently connected together, preferably by glue or the like, to form the lower mixing compartment 14.

Second, a rotation mechanism 94 of the blender 10, including the upper cover 12, the intermediate gearwheel 24, the pinion 28, the cover plate 46, and the rotor 40 is assembled.

At a first step, the central pin 32 of the intermediate gearwheel 24 is inserted into the fixing hole 48 of the cover plate 46. Then, the driving shaft 34 of the pinion 28 is inserted through the center hole 44 of the cover plate 46 while bringing the pinion 28 in contact engagement with the intermediate gearwheel 24. Now, the cover plate 46, with the intermediate gearwheel 24 and the pinion 28 placed thereon, is engaged with the upper cover 12 such that the peripheral edge 50 of the cover plate 46 is locked by the locking protrusions 20 of the upper cover 12. At a final stage, the rotor 40 is placed on the driving shaft 34 of the pinion 28 such that the driving shaft 34 is inserted into the central aperture 36 of the rotor 40 and they may be glued together.

For using the blender 10, the ingredients that should be mixed together are placed at the center of the mixing plate 54. Then, the upper cover 12 is lowered onto the lower mixing compartment 14 such that the fixing pin 52 of the cover plate 46 engages into one of the fixing indentations 72 of the mixing plate 54. In this position, the cover plate 46 is stationary with respect to the lower mixing compartment 14, and hence, the position of the axis of rotation B of the intermediate gearwheel 24 is stationary, and the intermediate gearwheel 24 is free to rotate around the axis of rotation B of the intermediate gearwheel 24.

During the entire operation of the blender 10, the upper cover 12 remains coupled to the lower mixing compartment 14 by the attraction between the upper magnet 42 and the lower magnet 58.

Since the axis of rotation B of the intermediate gearwheel 24 is stationary, rotation of the upper cover 12 in one given direction turns the intermediate gearwheel 24 in the same given direction. Thus, since the pinion 28 is aligned with the longitudinal axis A of the blender 10, rotation of the intermediate gearwheel 24 in one given direction turns the pinion 28 in an opposite direction (i.e., a direction opposite to the given direction).

Since the rotor 40 performs effective blending and wiping in one direction only, it is ensured that the rotor 40 may freely rotate in that direction, and, rotation in the opposite direction is prevented.

In the illustrated embodiment, in order to blend the mixture, the blender 10 is held within a palm of a user, the left palm in this case. Then, the upper cover 12 is rotated, by the right hand, clockwise several times.

Since, in the present embodiment, the pinion 28 has 10 teeth, the intermediate gearwheel 24 has 24 teeth and the internal gear 16 has 58 teeth, a gear ratio of (58/24)×(24/10)=5.8 is obtained. This means that for every turn of the upper cover 12, the pinion 28, and the rotor 40 that is connected to the driving shaft 34 of the pinion, rotate 5.8 turns. In this manner, a relatively small and slow rotation of the upper cover 12 by hand ends in a much larger and faster rotation of the rotor 40 thus positively affecting the blending of the mixture.

Thus, with a few turns of the upper cover 12, effective blending of the mixture is obtained in a few seconds. Now, for using the mixture, the upper cover 12 is lifted from the lower mixing compartment 14, and, the mixture that is concentrated entirely in the first zone 64 of the mixing plate 54 may be used. If the mixture is not used in its entirety, then, the remaining mixture may safely remain within the blender 10 until reused. In that manner, practically no ingredients are wasted. If it is desired to clean the blender 10 and prepare it for reuse, it can be done effectively by using a makeup remover.

When the upper cover 12 is turned clockwise, which is an upper cover rotation direction S2, the rotor 40 turns counterclockwise, in the rotor rotation direction S1. During the rotation of the upper cover 12 in the upper cover rotation direction S2, when a directional guide 22 of the upper cover 12 meets a directional stopper 78 of the lower mixing compartment 14, a guide slanted surface 96 of the directional guide 22 slides on a stopper slanted surface 98 of the directional stopper 78. During this slide, the upper cover 12 moves axially away from the lower mixing compartment 14 until the directional guide 22 ends its travel on the directional stopper 78. Since there are various directional guides 22 and various directional stoppers 78, four of each in the present embodiment, intermittent axial movement between the upper cover 12 and the lower mixing compartment 14 is obtained.

During the axial movement and during the rotation of the upper cover 12 with respect to the lower mixing compartment 14, the upper cover 12 and the lower mixing compartment 14 are attracted to each other by means of the attraction between the upper magnet 42 and the lower magnet 58.

The intermittent axial movement of the upper cover 12 during its rotation with respect to the lower mixing compartment 14 further improves the blending of the mixture that is obtained by the rotor 40.

With additional reference to FIG. 13, if the user of the blender 10 tries to rotate the upper cover 12 in a direction that is opposite the upper cover rotation direction S2, i.e., counterclockwise, then, a rear wall 100 of a directional guide 22, that is substantially planar and lies within a radial plane (not shown) that passes through the longitudinal axis A or parallel thereto, is blocked by a front wall 102 of a directional stopper 78, that is directed similar to the rear wall 100 of a directional guide 22, thus preventing rotation of the upper cover 12 in a wrong direction with respect to the lower mixing compartment 14, and forming a one-direction rotation mechanism 104.

Although the present invention has been described to a certain degree of particularity, it should be understood that various alterations and modifications could be made without departing from the spirit or scope of the invention as hereinafter claimed.

For example, the blender is not limited to blend makeup foundation only and other cosmetic mixtures may be blended, such as concealer tones and the like.

The blender is not limited to blend cosmetic mixtures only, and other types of mixtures may be blended, such as pharmaceutical compounds, chemical materials, biological substances, and the like.

The number of locking protrusions is not limited to four and any number of locking protrusions may be equally applicable, as long as they enable proper close-fit between the upper cover and the cover plate.

The close-fit between the upper cover and the cover plate is not limited to be performed with locking protrusions and any other method that enables a close-fit between the upper cover and the cover plate may be equally applicable.

The rotor is not limited to have two blades only and other number of blades, starting from one and up, may be equally applicable.

The blades of the rotor do not have to be identical and according to some embodiments each blade has a different design for serving a different function when blending and wiping a mixture.

The connection of the mixing plate to the lower holding compartment may be by close-fit, by gluing, or by any other connection method applicable to the structure of the blender.

The lower mixing compartment does not have to be formed from two separated parts that are assembled together. According to some embodiments, the lower mixing compartment is formed from a single piece.

The concave indentation of the mixing plate does not have to be formed from four zones and shaped as described above, and other number of zones and shapes may be formed according to specific design needs.

The fixing indentations of the mixing plate are not limited to the eight indentations shown in the figures, and other number of fixing indentations may be chosen according to design needs.

The shape of a fixing indentation does not have to conform with the shape of the fixing pin, as long as the fixing indentation prevents rotation of the fixing pin around the longitudinal axis of the blender.

Prevention of rotation of the cover plate around the longitudinal axis of the blender is not limited to be done by a fixing pin that mates with a corresponding fixing indentation, and other rotation prevention means may be equally applicable.

The mixing plate is not limited to comprise four directional stoppers and other number of stoppers may be equally applicable, as long as there is at least one directional stopper, for preventing rotation of the upper cover in the wrong direction with respect to the lower mixing compartment.

The upper cover is not limited to comprise four directional guides and other number of guides may be equally applicable, as long as there is at least one directional guide, for being stopped by a directional stopper for preventing rotation of the upper cover in the wrong direction with respect to the lower mixing compartment.

Prevention of rotation in the wrong direction does not have to be carried out by directional guides and directional stoppers as described, and other wrong-direction rotation preventive means may be used.

The rotor is not limited to have two cutouts in each wing, and other number of cutouts may be equally applicable. Furthermore, according to some embodiments, the rotor does not have any cutouts on the bottom surface of each wing.

The cutouts of each wing do not have to be equally radially spaced from the longitudinal axis. According so some embodiments, a cutout of a given wing overlaps, radially, i.e., at the same distance from the longitudinal axis, a wiping protrusion of another wing, and a wiping protrusion of the given wing overlaps, radially, a cutout of the other wing.

The pinion, the intermediate gearwheel and the internal gear do not have to have the same number of teeth as shown in the described embodiment and they may have other numbers of teeth, resulting in a gear ratio different from the one described, thus achieving any suitable gear ratio.

The blender is not limited to comprise two magnets that attract each other in order to provide engagement between the upper cover and the lower mixing compartment during operation of the blender. If desired, a slight pressure exerted by the user on the upper cover against the lower mixing compartment may be sufficient for successful operation of the blender.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

As used herein, the singular form, “a”, “an” and “the” include plural references unless the context clearly dictates otherwise.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

To the extent that the appended claims have been drafted without multiple dependencies, this has been done only to accommodate formal requirements in jurisdictions which do not allow such multiple dependencies. It should be noted that all possible combinations of features which would be implied by rendering the claims multiply dependent are explicitly envisaged and should be considered part of the invention.

1. A blender (10) for blending a plurality of ingredients, the blender comprising:
an upper cover (12), comprising a rotation mechanism (94), the upper cover fitted on a lower mixing compartment (14), wherein:
the rotation mechanism comprises a rotor (40), and
rotation of the upper cover rotates the rotor, and the rotor blends the multitude of ingredients within the lower mixing compartment for receiving a blended mixture.

2. The blender according to claim 1, wherein the ingredients include cosmetic ingredients.

3. The blender according to claim 1, wherein the plurality of ingredients are makeup foundations.

4. The blender according to claim 1, wherein the plurality of ingredients are concealer tones.

5. The blender according to claim 1, wherein the lower mixing compartment (14) comprises a concave indentation (62) in a lower portion thereof, and, rotation of the rotor (40) blends the mixture within the lower mixing compartment and wipes the mixture from the concave indentation.

6. The blender according to claim 1, wherein the rotor (40) comprises a center hub (38) and at least one wing (80) extending generally radially outwardly from the hub.

7. The blender according to claim 6, wherein a bottom surface (86) of the at least one wing (80) comprises at least one upwardly extending cutout (88, 90).

8. The blender according to claim 7, wherein the bottom surface (86) of the at least one wing (80) comprises at least one wiping protrusion (92) formed between two adjacent cutouts (88, 90).

9. The blender according to claim 5, wherein the rotor (40) comprises a center hub (38) having a bottom wall (82), and the bottom wall of the hub mates with a shape of the concave indentation (62).

10. The blender according to claim 5, wherein the concave indentation (62) comprises a plurality of zones (64, 66, 68, 70), each of which extends radially outwardly from a former zone.

11. The blender according to claim 10, wherein each of the plurality of zones (64, 66, 68, 70) having a different radius of curvature.

12. The blender according to claim 1, wherein the rotation mechanism (94) comprises gearwheels (16, 24, 28) mechanically linked such as to increase rotation speed and number of turns of the rotor (40) with respect to rotation speed and number of turns of the upper cover (12).

13. The blender according to claim 12, wherein the rotor (40) is mechanically linked to a driving shaft (34) of a pinion (28) that is aligned with a longitudinal axis (A) of the blender,
the pinion is engaged with an intermediate gearwheel (24) having an axis of rotation (B) that is fixed with respect to the lower mixing compartment (14),
the intermediate gearwheel is engaged with an internal gear (16) formed in an internal portion of the upper cover (12), and wherein
rotation of the upper cover (12) in an upper cover rotation direction (S2) turns the rotor (40) in a rotor rotation direction (S1) that is opposite the upper cover rotation direction.

14. The blender according to claim 13, wherein the intermediate gearwheel (24) comprises a central pin (32) extending downwardly therefrom,
the central pin is held within a fixing hole (48) of a cover plate (46) that is fixed with respect to the lower mixing compartment (14), and wherein
the central pin can freely rotate within the fixing hole, while any translational movement of the central pin in a plane perpendicular to the longitudinal axis (A) of the blender is successfully prevented.

15. The blender according to claim 14, wherein the cover plate (46) comprises a fixing pin (52) extending downwardly therefrom,
the fixing pin conforms in size and shape to a fixing indentation (72) formed in the lower mixing compartment (14), and wherein
insertion of the fixing pin into the fixing indentation prevents any rotational movement of the cover plate with respect to the lower mixing compartment.

16. The blender according to claim 15, wherein the lower mixing compartment (14) comprises a plurality of fixing indentations (72).

17. The blender according to claim 1, wherein the upper cover (12) comprises an upper magnet (42), the lower mixing compartment (14) comprises a lower magnet (58), and wherein
the upper cover remains engaged with the lower mixing compartment by the attraction between the upper magnet and the lower magnet.

18. The blender according to claim 17, wherein the upper magnet (42) is aligned with a longitudinal axis (A) of the blender and is embedded within a driving shaft (34) that rotates the rotor (40).

19. The blender according to claim 17, wherein the lower mixing compartment (14) is assembled from a mixing plate (54) that is engaged with a lower holding compartment (56),
the lower magnet (58) is embedded into the lower holding compartment from an upper side thereof, and wherein
when the mixing plate is engaged with the lower holding compartment, the lower magnet cannot be seen from outside the blender.

20. The blender according to claim 1, wherein
the upper cover (12) comprises at least one directional guide (22),
the lower mixing compartment (14) comprises at least one directional stopper (78), and wherein
when the upper cover is engaged with the lower mixing compartment and rotated in an upper cover rotation direction (S2) until the at least one directional guide meets the at least one directional stopper, rotation of the rotor (40) in a rotor rotation direction (S1) is enabled, and wherein
when the upper cover is rotated in a direction opposite to the upper cover rotation direction, rotation of the upper cover with respect to the lower mixing compartment is prevented, and a one-direction rotation mechanism (104) is obtained.

21. The blender according to claim 20, wherein
when the upper cover (12) is rotated in an upper cover rotation direction (S2) until the at least one directional guide (22) meets the at least one directional stopper (78), a guide slanted surface (96) of the directional guide slides on a stopper slanted surface (98) of the directional stopper, thus moving the upper cover axially away from the lower mixing compartment (14) until the directional guide ends its travel on the directional stopper, then, the upper cover moves axially back toward the lower mixing compartment, thus obtaining an intermittent axial movement of the upper cover with respect to the lower mixing compartment during rotation of the upper cover in an upper cover rotation direction with respect to the lower mixing compartment.

22. The blender according to claim 20, wherein the upper cover (12) comprises four directional guides (22), and, the lower mixing compartment (14) comprises four directional stoppers (78).
